(19) United States
(12) Patent Application Publication
(10) Pub. No.: US 2011/0074754 A1
(43) Pub. Date: Mar. 31, 2011

(54) DEVICE FOR GENERATING RGB GAMMA VOLTAGE AND DISPLAY DRIVING APPARATUS USING THE SAME

(75) Inventors: Youn Joong LEE, Seoul (KR); Kyoung Soo KWON, Yongin-Si (KR); Byoung Won HWANG, Hwaseong-Si (KR)

(73) Assignee: Samsung Electro-Mechanics Co., Ltd., Suwon-si (KR)

(21) Appl. No.: 12/626,842

(22) Filed: Nov. 27, 2009

(30) Foreign Application Priority Data
Sep. 25, 2009 (KR) 10-2009-0091122

(51) Int. Cl. G09G 5/00

(52) U.S. Cl. 345/211

(57) ABSTRACT

The present invention relates to a device for generating RGB gamma voltage and a display driving apparatus using the same. The device for generating RGB gamma voltage includes: an RGB gamma compensation voltage output unit that outputs a plurality of R, G, B gamma compensation voltage corresponding to gamma compensation data with respect to R, G, and B signals; a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; and a multiplexer controller that generates an RGB selection control signal corresponding to an output order of the R, G, and B signals and transmits the generated signal to the multiplexer and controls the signal outputted from the multiplexer in accordance with the RGB selection control signal.

### CROSS-REFERENCE TO RELATED APPLICATIONS

This application claims the benefit of Korean Patent Application No. 10-2009-0091122 filed with the Korea Intellectual Property Office on Sep. 25, 2009, the disclosure of which is incorporated herein by reference.

### BACKGROUND OF THE INVENTION

1. Field of the Invention

The present invention relates to a device for generating RGB gamma voltage and a display driving apparatus using the same and, more particularly, to a device for generating RGB gamma voltage which sequentially outputs R, G, and B signals by generating a plurality of R, G, and B independent gamma compensation voltages and a display driving apparatus using the same.

2. Description of the Related Art

Recently, in an informationization society, importance of display devices as a visual information transmission medium is being emphasized than ever before and various kinds of flat panel display devices are being developed.

The flat panel display includes a liquid crystal display (LCD), a field emission display (FED), a plasma display panel (PDP), an electroluminescence (EL), etc.

In general, an application range of the LCD is tending to be increasingly widen due to characteristics due to light weight, thin thickness, low-power consumption driving, etc. and with the tendency, the LCD is used for a portable computer such as a notebook and a PC, an office automation equipment, an audio/video equipment, an indoor and outdoor advertisement display device, etc. In addition, recently, the LCD is being rapidly developed to enlargement and high resolution by securing a production technology and performance of research and development.

Typically, the general flat panel display displays an image by controlling the light transmittance of a liquid crystal cell in accordance with a video signal and has a unique gamma property.

The gamma property means an inclination of a luminance characteristic curve in accordance with a voltage level outputted from an output terminal of a source drive IC and a variation in a luminance value at the time of displaying input/output characteristics in an optoelectrical conversion system or an electroptical conversion system of a television, a camera, a photoelectric conversion system, a monitor, etc.

Image quality characteristics are determined depending on the voltage outputted from the source drive IC. That is, a plurality of gray level values between white voltage and block voltage are outputted from the source drive IC and the outputted value is determined for each step by a resistor and a resistance component in the IC.

A gamma voltage generator generating the gamma voltage is classified into an R, G, B independent gamma scheme and an R, G, B common gamma scheme. The R, G, B independent gamma scheme having various colors which can be expressed and compensated is primarily used.

In order to implement R, G, B independent gamma voltage, a resistor array, a plurality of voltage selectors, a buffer circuit, etc. are provided. Since the components should be present with respect to each of R, G, and B, the number of wires connected to each channel is triple and the size of a chip is increased and a unit cost is increased due to routing of each wire.

### SUMMARY OF THE INVENTION

An object of the present invention is to provide a device for generating RGB gamma voltage which selects and outputs three R, G, B independent gamma compensation voltages generated by a gamma voltage generator as R, G, and B signals by using one wire by including a multiplexer and a demultiplexer and a display driving apparatus using the same.

In accordance with an embodiment of the present invention, there is provided a device for generating RGB gamma voltage that includes: an RGB gamma compensation voltage output unit that outputs a plurality of R, G, B gamma compensation voltage corresponding to gamma compensation data with respect to R, G, and B signals; a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; and a multiplexer controller that generates an RGB selection control signal corresponding to an output order of the R, G, and B signals and transmits the generated signal to the multiplexer and controls the signal outputted from the multiplexer in accordance with the RGB selection control signal.

In accordance with another embodiment of the present invention, there is provided a device for generating RGB gamma voltage that includes: an RGB gamma compensation voltage output unit that outputs a plurality of R, G, B gamma compensation voltage corresponding to gamma compensation data with respect to R, G, and B signals; a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; a demultiplexer that receives the gamma compensation voltage outputted from the multiplexer and outputs the received gamma compensation voltage by selecting R, G, and B output lines corresponding to the RGB selection control signal; and a controller that generates the RGB selection control signal for determining an output order of the R, G, and B signals outputted from the multiplexer and transmits the generated RGB selection control signal to the multiplexer and the demultiplexer.

Further, in accordance with the embodiment of the present invention, the RGB gamma compensation voltage output unit of the RGB gamma voltage generating device may include: a maximum/minimum voltage determination member that determines the intensities of maximum gamma voltage and minimum gamma voltage; a plurality of medium voltage distribution member that receive signals corresponding to the intensities of the gamma voltages and distribute the received signals as medium voltage; and a gamma voltage output member that receives the medium voltage from the plurality of medium voltage distribution members and generates a plurality of voltage levels within two medium voltages as gamma compensation voltage.

Further, in accordance with the embodiment of the present invention, the maximum/minimum voltage determination member, the medium voltage distribution members, and the gamma voltage output member of the RGB gamma voltage generating device may include a plurality of resistance elements and a plurality of switching elements that are connected to each other in series.

Further, in accordance with the embodiment of the present invention, the multiplexer of the RGB gamma voltage generating device may further include a channel buffer unit having a plurality of channels.

In accordance with another embodiment of the present invention, a display driving apparatus includes: an RGB gamma compensation voltage generation module that selectively outputs any one gamma compensation voltage among R gamma compensation voltage, G gamma compensation voltage, and B gamma compensation voltage in synchronization with RGB selection signals; and a conversion module that converts an R signal, a G signal, or a B signal corresponding to the RGB gamma compensation voltage into voltage to be applied to a corresponding pixel of a display panel.

Further, in accordance with the embodiment of the present invention, the RGB selection control signal of the display driving apparatus may control the R, G, and B signals to be outputted to the conversion module in sequence.

In accordance with the embodiment of the present invention, the RGB gamma compensation voltage generation module of the display driving apparatus may include: an RGB gamma compensation voltage output unit that outputs a plurality of R, G, B gamma compensation voltage corresponding to gamma compensation data with respect to R, G, and B signals; a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; and a multiplexer controller that generates an RGB selection control signal corresponding to an output order of the R, G, and B signals and transmits the generated signal to the multiplexer and controls the signal outputted from the multiplexer in accordance with the RGB selection control signal.

Further, in accordance with the embodiment of the present invention, the RGB gamma compensation voltage generation module of the display driving apparatus may include: an RGB gamma compensation voltage output unit that outputs a plurality of R, G, B gamma compensation voltage corresponding to gamma compensation data with respect to R, G, and B signals; a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; a demultiplexer that receives the gamma compensation voltage outputted from the multiplexer and outputs the received gamma compensation voltage by selecting R, G, and B output lines corresponding to the RGB selection control signal; and a controller that generates the RGB selection control signal for determining an output order of the R, G, and B signals outputted from the multiplexer and transmits the generated RGB selection control signal to the multiplexer and the demultiplexer.

Further, in accordance with the embodiment of the present invention, the RGB gamma compensation voltage output unit of the display driving apparatus may include: a maximum/minimum voltage determination member that determines the intensities of maximum gamma voltage and minimum gamma voltage; a plurality of medium voltage distribution member that receive signals corresponding to the intensities of the gamma voltages and distribute the received signals as medium voltage; and a gamma voltage output member that receives the medium voltage from the plurality of medium voltage distribution members and generates a plurality of voltage levels within two medium voltages as gamma compensation voltage.

Further, in accordance with the embodiment of the present invention, the maximum/minimum voltage determination member, the medium voltage distribution members, and the gamma voltage output member of the display driving apparatus may include a plurality of resistance elements and a plurality of switching elements that are connected to each other in series.

Further, in accordance with the embodiment of the present invention, the multiplexer of the display driving apparatus may further include an output buffer unit having a plurality of channels.

In accordance with an embodiment of the present invention, since routing wires of the R, G, B independent gamma voltage output terminals can be simplified by disposing a multiplexer circuit on the output terminals of the R, G, B independent gamma voltage, it is possible to reduce a dimension generated by the wire routing to ⅓ of the known scheme.

Further, since R, G, and B signals can be selected and outputted in synchronization with a control signal for controlling R, G, and B signals transmitted in time division from the multiplexer circuit by including a demultiplexer circuit, the R, G, and B signals can be sequentially transmitted to a pixel.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a diagram showing a configuration of a device for generating RGB gamma voltage in accordance with an embodiment of the present invention;

FIG. 2 is a diagram showing a configuration of a device for generating RGB gamma voltage in accordance with another embodiment of the present invention;

FIG. 3 is a diagram showing a configuration of an RGB gamma compensation voltage output unit of an RGB gamma voltage generating device in accordance with an embodiment of the present invention; and

FIG. 4 is a diagram showing a configuration of a display driving apparatus in accordance with another embodiment of the present invention.

### DETAILED DESCRIPTION OF THE PREFERABLE EMBODIMENTS

Although the present invention can be modified variously and have several embodiments, the exemplary embodiments are illustrated in the accompanying drawings and will be described in detail in the detailed description. However, the present invention is not limited to the specific embodiments and should be construed as including all the changes, equivalents, and substitutions included in the spirit and scope of the present invention.

Hereinafter, a device for generating RGB gamma voltage and a display driving apparatus using the same in accordance with an embodiment of the present invention will be described in detail with reference to the accompanying drawings. Like elements refer to like reference numerals irrespective of reference numerals. A duplicated description thereof will be omitted.

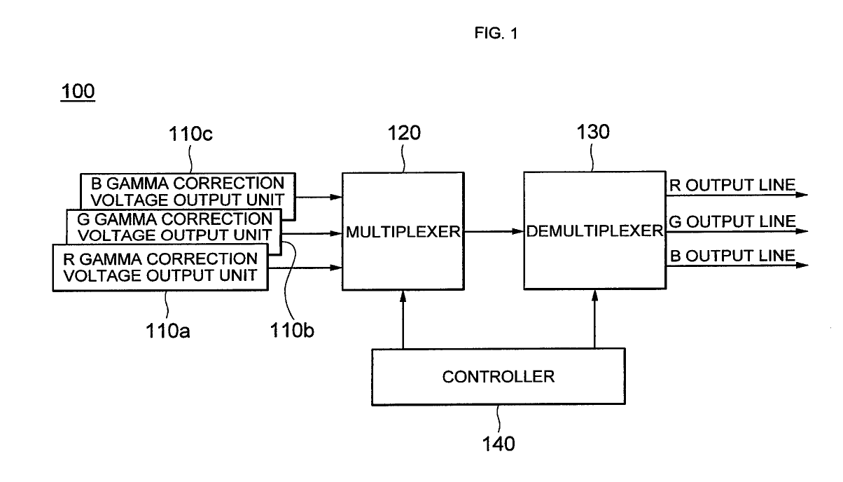

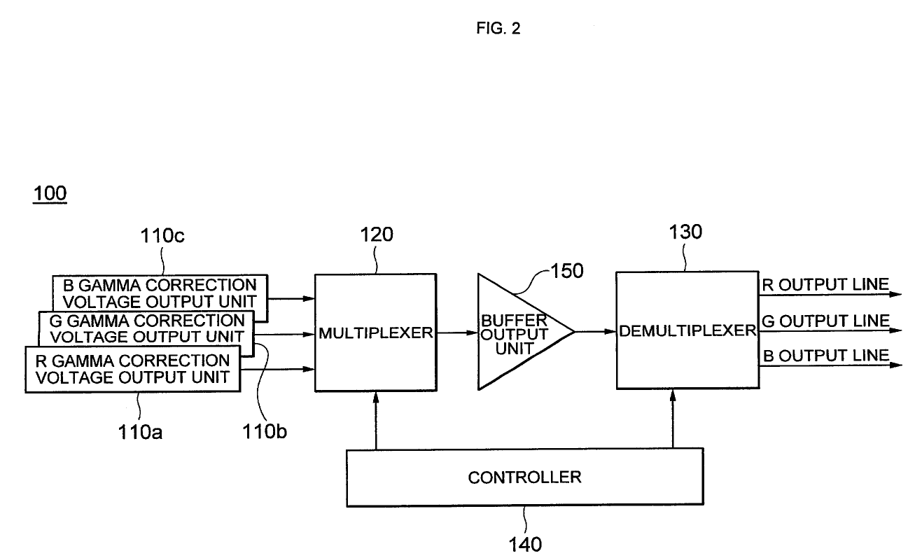

FIG. 1 is a diagram showing a configuration of a device for generating RGB gamma voltage in accordance with an embodiment of the present invention and FIG. 2 is a diagram showing a configuration of a device for generating RGB gamma voltage in accordance with another embodiment of the present invention.

As shown in FIG. 1, the RGB gamma voltage generating device 100 in accordance with the embodiment of the present invention includes RGB gamma compensation voltage output units 110a, 110b, and 110c, a multiplexer 120, a demultiplexer 130, and a controller 140.

The RGB gamma compensation voltage output units 110a, 110b, and 110c includes an R gamma compensation voltage output unit 110a, a G gamma compensation voltage output unit 110b, and a B gamma compensation voltage output unit 110c and can output a plurality of R, G, B gamma compensation voltages corresponding to gamma compensation data with respect to the R, G, and B signals, respectively.

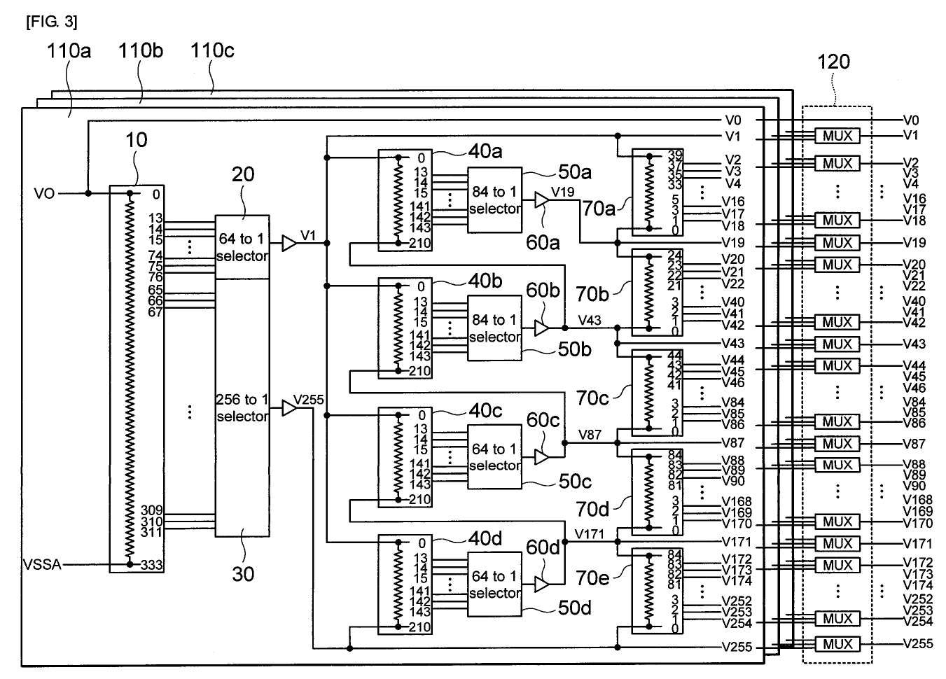

FIG. 3 is a diagram showing a configuration of an RGB gamma compensation voltage output unit of an RGB gamma voltage generating device in accordance with an embodiment of the present invention.

As shown in FIG. 3, the RGB gamma compensation voltage output units 110a, 110b, and 110c include maximum/minimum voltage determination members 20 and 30, medium voltage distribution members 40a to 40d and 50a to 50d, and gamma voltage output members 70a to 70e.

The maximum/minimum voltage determination members 20 and 30 can determine the intensities of maximum gamma voltage and minimum gamma voltage. That is, the maximum/minimum voltage determination members 20 and 30 can determine maximum voltage indicating a minimum gray level and minimum voltage indicating a maximum gray level among voltage levels between maximum power supply voltage and minimum power supply voltage inputted from the outside.

The plurality of medium voltage distribution members 40a to 40d and 50a to 50d can receive a signal corresponding to the intensity of the maximum or minimum gamma voltage and distribute the signal as medium voltage.

The gamma voltage output members 70a to 70e receive the medium voltage from the plurality of medium voltage distribution members 40a to 40d and 50a to 50d to generate a plurality of voltage levels within two medium voltage ranges as the gamma compensation voltage.

Herein, the maximum/minimum voltage determination members 20 and 30, the medium voltage distribution members 40a to 40 and 50a to 50d, and the gamma voltage output members 70a to 70e include a plurality of resistance elements and a plurality of switching elements that are connected to each other in series, and can distribute and output the voltage level between the inputted maximum power supply voltage and the inputted minimum power supply voltage into plural.

The multiplexer 120 receives the R, G, B gamma compensation voltages among the outputted gamma compensation voltages one by one, and selects and outputs any one gamma compensation voltage among the R, G, B gamma compensation voltages in accordance with an RGB selection control signal.

The demultiplexer 130 receives the gamma compensation voltage outputted from the multiplexer 120 and outputs the received gamma compensation voltage by selecting R, G, B output lines corresponding to the RGB selection control signals.

That is, when the R, G, and B signals are transmitted in time division from the multiplexer 120, the demultiplexer 130 can output the R, G, and B signals to the output lines to correspond to a transmission order of the RGB signals.

The controller 140 generates the RGB selection control signals for determining the output order of the R, G, and B signals outputted from the multiplexer 120 to transmit the generated signals to the multiplexer 120 and the demultiplexer 130. A multiplexer controller (not shown) to control an operation of the multiplexer 120 by transmitting the RGB selection control signals to the multiplexer may be included in the controller 140.

An RGB gamma voltage generating device 100 in accordance with another embodiment of the present invention includes RGB gamma compensation voltage output units 110a, 110b, and 110c, a multiplexer 120, a demultiplexer 130, a controller 140, and a buffer unit 150.

As shown in FIG. 2, the RGB gamma voltage generating device 100 in accordance with another embodiment of the present invention further includes the buffer unit 150 at an output terminal of the multiplexer 120.

The buffer unit 150 includes a plurality of channels CH1, CH2, and CH3 to stabilize and output gamma compensation voltage outputted from the multiplexer 120.

Herein, the RGB gamma compensation voltage output units 110a, 110b, and 110c include an R gamma compensation voltage output unit 110a, a G gamma compensation voltage output unit 110b, and a B gamma compensation voltage output unit 110c and can output a plurality of R, G, B gamma compensation voltages corresponding to gamma compensation data with respect to the R, G, and B signals, respectively. The RGB gamma compensation voltage output units 110a, 110b, and 110c include maximum/minimum voltage determination members, medium voltage distribution members, and gamma voltage output members with respect to R, G, and B signals.

The maximum/minimum voltage determination members, the medium voltage distribution members, and the gamma voltage output members include a plurality of resistance elements and a plurality of switching elements and can distribute and output a voltage level between the inputted maximum power supply voltage and the inputted power supply voltage in plural.

The multiplexer 120 receives the R, G, B gamma compensation voltages among the outputted gamma compensation voltages one by one, and selects and outputs any one gamma compensation voltage among the R, G, B gamma compensation voltages in accordance with an RGB selection control signal.

The gamma compensation voltage selected and outputted by the multiplexer 120 is stabilized by the buffer unit 150 and is outputted as the output voltage equal to input voltage of the multiplexer 120 through each of channels CH1, CH2, and CH3.

The voltage outputted from the buffer unit 150 is transmitted to the demultiplexer 130 and outputted by selecting R, G, B output lines corresponding to the RGB selection control signals.

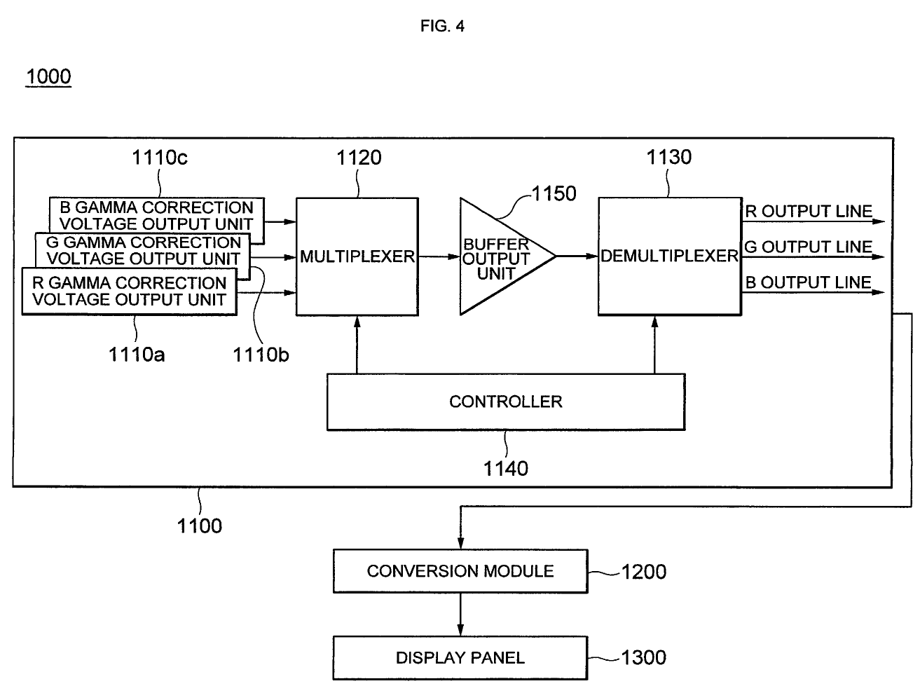

FIG. 4 is a diagram showing a configuration of a display driving apparatus in accordance with another embodiment of the present invention.

As shown in FIG. 4, the display driving apparatus 1000 in accordance with another embodiment of the present invention includes an RGB gamma compensation voltage generation module 1100 and a conversion module 1200.

The RGB selection control signal is a control signal to select any one signal to be transmitted among the R, G, and B signals and the RGB signal selection module 1100 controls the R, G, and B signals to be outputted to the conversion module 1200 in sequence.

The RGB gamma compensation voltage generation module 1100 can selectively output any one gamma compensation voltage among R gamma compensation voltage, G gamma compensation voltage, and B gamma compensation voltage in synchronization with the RGB selection control signal.

The RGB gamma compensation voltage generation module 1100 may include RGB gamma compensation voltage output units 1110a to 1110c, a multiplexer 1120, a demultiplexer 1130, a controller 1140 and the controller 1140 may include a multiplexer controller, and a buffer unit 1150 may be additionally provided at an output terminal of the multiplexer.

The RGB gamma compensation voltage output units 1110a to 1110c can output a plurality of R, G, B gamma compensation voltages corresponding to gamma compensation data with respect to R, G, and B signals.

The multiplexer 1120 receives the R, G, B gamma compensation voltages among the outputted gamma compensation voltages one by one, and selects and outputs any one gamma compensation voltage among the R, G, B gamma compensation voltages in accordance with an RGB selection control signal. The demultiplexer 1130 receives the gamma compensation voltage outputted from the multiplexer 1120 and outputs the received gamma compensation voltage by selecting R, G, B output lines corresponding to the RGB selection control signals.

The controller 1140 generates the RGB selection control signals for determining the output order of the R, G, and B signals outputted from the multiplexer 1120 and transmits the generated signals to the multiplexer 1120 and the demultiplexer 1130 to match input/output synchronization of each signal.

The multiplexer 1120 may include a plurality of multiplexer circuits and one R, G, B gamma compensation voltage is selected among a plurality of R, G, B gamma compensation voltages to be routed through one wire.

The RGB gamma compensation voltage output units 1110a to 1110c include a maximum/minimum voltage determination member, a plurality of medium voltage distribution members, and a gamma voltage output member. The maximum/minimum voltage determination member, the medium voltage distribution member, and the gamma voltage output member include a plurality of resistance elements and a plurality of switching elements that are connected to each other in series to generate gamma compensation voltages of a plurality of voltage levels.

The conversion module 1200 can convert the R signal, the G signal, or the B signal corresponding to the RGB gamma compensation voltage into voltage to be applied to a corresponding pixel of the display panel 1300.

Accordingly, the RGB gamma voltage generating device and the display driving apparatus using the same in accordance with the present invention can simplify a configuration of a circuit and reduce the size of a chip by routing wires for independent gamma compensation voltages with respect to the R, G, and B signals, respectively as one wire by using the multiplexer.

Further, since the control signal synchronized with the RGB selection control signal of the multiplexer can control the output order of the R, G, and B gamma voltages outputted from the demultiplexer, the control signal can serves to perform the same function as the known gamma voltage generator.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A device for generating RGB gamma voltage, comprising:
an RGB gamma compensation voltage output unit that outputs a plurality of R, G, B gamma compensation voltage corresponding to gamma compensation data with respect to R, G, and B signals;
a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal; and
a multiplexer controller that generates an RGB selection control signal corresponding to an output order of the R, G, and B signals and transmits the generated signal to the multiplexer and controls the signal outputted from the multiplexer in accordance with the RGB selection control signal.

2. A device for generating RGB gamma voltage, comprising:
an RGB gamma compensation voltage output unit that outputs a plurality of R, G, B gamma compensation voltage corresponding to gamma compensation data with respect to R, G, and B signals;
a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal;
a demultiplexer that receives the gamma compensation voltage outputted from the multiplexer and outputs the received gamma compensation voltage by selecting R, G, and B output lines corresponding to the RGB selection control signal; and
a controller that generates the RGB selection control signal for determining an output order of the R, G, and B signals outputted from the multiplexer and transmits the generated RGB selection control signal to the multiplexer and the demultiplexer.

3. The device for generating RGB gamma voltage of claim 1, wherein the RGB gamma compensation voltage output unit includes:
a maximum/minimum voltage determination member that determines the intensities of maximum gamma voltage and minimum gamma voltage;
a plurality of medium voltage distribution member that receive signals corresponding to the intensities of the gamma voltages and distribute the received signals as medium voltage; and
a gamma voltage output member that receives the medium voltage from the plurality of medium voltage distribution members and generates a plurality of voltage levels within two medium voltages as gamma compensation voltage.

4. The device for generating RGB gamma voltage of claim 2, wherein the RGB gamma compensation voltage output unit includes:
a maximum/minimum voltage determination member that determines the intensities of maximum gamma voltage and minimum gamma voltage;
a plurality of medium voltage distribution member that receive signals corresponding to the intensities of the gamma voltages and distribute the received signals as medium voltage; and
a gamma voltage output member that receives the medium voltage from the plurality of medium voltage distribution members and generates a plurality of voltage levels within two medium voltages as gamma compensation voltage.

5. The device for generating RGB gamma voltage of claim 3, wherein the maximum/minimum voltage determination member, the medium voltage distribution members, and the gamma voltage output member include a plurality of resistance elements and a plurality of switching elements that are connected to each other in series.

6. The device for generating RGB gamma voltage of claim 1, wherein the multiplexer further includes a channel buffer unit having a plurality of channels.

7. The device for generating RGB gamma voltage of claim 2, wherein the multiplexer further includes a channel buffer unit having a plurality of channels.

8. A display driving apparatus, comprising:
an RGB gamma compensation voltage generation module that selectively outputs any one gamma compensation voltage among R gamma compensation voltage, G gamma compensation voltage, and B gamma compensation voltage in synchronization with RGB selection signals; and
a conversion module that converts an R signal, a G signal, or a B signal corresponding to the RGB gamma compensation voltage into voltage to be applied to a corresponding pixel of a display panel.

9. The display driving apparatus of claim 8, wherein the RGB selection control signal controls the R, G, and B signals to be outputted to the conversion module in sequence.

10. The display driving apparatus of claim 8, wherein the RGB gamma compensation voltage generation module includes:
an RGB gamma compensation voltage output unit that outputs a plurality of R, G, B gamma compensation voltage corresponding to gamma compensation data with respect to R, G, and B signals;
a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal;
a multiplexer controller that generates an RGB selection control signal corresponding to an output order of the R, G, and B signals and transmits the generated signal to the multiplexer and controls the signal outputted from the multiplexer in accordance with the RGB selection control signal.

11. The display driving apparatus of claim 8, wherein the RGB gamma compensation voltage generation module includes:
an RGB gamma compensation voltage output unit that outputs a plurality of R, G, B gamma compensation voltage corresponding to gamma compensation data with respect to R, G, and B signals;
a multiplexer that receives the R, G, and B gamma compensation voltages among the outputted gamma compensation voltages one by one and selects and outputs any one gamma compensation voltage among the R, G, and B gamma compensation voltages in accordance with an RGB selection control signal;
a demultiplexer that receives the gamma compensation voltage outputted from the multiplexer and outputs the received gamma compensation voltage by selecting R, G, and B output lines corresponding to the RGB selection control signal; and
a controller that generates the RGB selection control signal for determining an output order of the R, G, and B signals outputted from the multiplexer and transmits the generated RGB selection control signal to the multiplexer and the demultiplexer.

12. The display driving apparatus of claim 10, wherein the RGB gamma compensation voltage output unit includes:
a maximum/minimum voltage determination member that determines the intensities of maximum gamma voltage and minimum gamma voltage;
a plurality of medium voltage distribution member that receive signals corresponding to the intensities of the gamma voltages and distribute the received signals as medium voltage; and
a gamma voltage output member that receives the medium voltage from the plurality of medium voltage distribution members and generates a plurality of voltage levels within two medium voltages as gamma compensation voltage.

13. The display driving apparatus of claim 10, wherein the maximum/minimum voltage determination member, the medium voltage distribution members, and the gamma voltage output member include a plurality of resistance elements and a plurality of switching elements that are connected to each other in series.

14. The display driving apparatus of claim 10, wherein the multiplexer further includes a channel buffer unit having a plurality of channels.
